(19) United States
(12) Patent Application Publication
(10) Pub. No.: US 2009/0136064 A1
(43) Pub. Date: May 28, 2009

(54) Vibration transducer and manufacturing method therefor

(75) Inventors: Tamito Suzuki, Fukuroi-shi (JP); Seiji Hirade, Fukuroi-shi (JP); Yukitoshi Suzuki, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/284,935

(22) Filed: Sep. 26, 2008

(30) Foreign Application Priority Data
Sep. 28, 2007 (JP) 2007-256905
Sep. 28, 2007 (JP) 2007-256906

(51) Int. Cl. H04R 25/00

(52) U.S. Cl. 381/174

(57) ABSTRACT

A vibration transducer is constituted of a substrate, a diaphragm having a conductive property, a plate having a conductive property, and a plurality of first spacers having pillar shapes which are formed using a deposited film having an insulating property joining the plate so as to support the plate relative to the diaphragm with a gap therebetween. It is possible to introduce a plurality of second spacers having pillar shapes support the plate relative to the substrate with a gap therebetween, and/or a plurality of third spacers having pillar shapes which support the diaphragm relative to the substrate with a gap therebetween. When the diaphragm vibrates relative to the plate, an electrostatic capacitance formed therebetween is varied so as to detect vibration with a high sensitivity. The diaphragm has a plurality of arms whose outlines are curved so that the intermediate regions thereof are reduced in width.

### BACKGROUND OF THE INVENTION

1. Field of the Invention

The present invention relates to vibration transducers and in particular to wave transducers such as miniature condenser microphones serving as MEMS sensors. The present invention also relates to manufacturing methods of vibration transducers.

The present application claims priority on Japanese Patent Application No. 2007-256905 and Japanese Patent Application No. 2007-256906, the contents of which are incorporated herein by reference.

2. Description of the Related Art

Various types of vibration transducers have been developed and disclosed in various documents such as Patent Documents 1, 2, 3 and Non-Patent Document 1.
Patent Document 1: Japanese Patent Application Publication No. H09-508777
Patent Document 2: Japanese Patent Application Publication No. 2004-506394
Patent Document 3: U.S. Pat. No. 4,776,019
Non-Patent Document 1: The paper entitled “MSS-01-34” published by the Japanese Institute of Electrical Engineers

Miniature condenser microphones have been conventionally known as typical types of vibration transducers and have been produced by way of semiconductor device manufacturing processes.

Condenser microphones are referred to as MEMS microphones (where MEMS stands for Micro Electro Mechanical System). A typical example of condenser microphones is constituted of a substrate, a diaphragm, and a plate. The diaphragm and plate serving as opposite electrodes, which are distanced from each other, are composed of films deposed on the substrate and are supported above the substrate. When the diaphragm vibrates due to sound waves relative to the plate, the electrostatic capacitance between the diaphragm and the plate varies due to the displacement of the diaphragm, and then variations of electrostatic capacitance are converted into electric signals. This condenser microphone (or vibration transducer) is designed such that the peripheral portion of the plate joins an insulating film.

In the structure in which the plate joins the insulating film, however, a parasitic capacitance occurs between the diaphragm or the substrate and the plate which joins the insulating film serving as a dielectric layer in the peripheral portion, thus reducing the sensitivity of the vibration transducer.

### SUMMARY OF THE INVENTION

It is an object of the present invention to provide a vibration transducer having high sensitivity.

It is another object of the present invention to provide a manufacturing method of the vibration transducer.

In a first aspect of the present invention, a vibration transducer includes a diaphragm having a conductive property, a plate having a conductive property, which is positioned opposite to the diaphragm, and a plurality of first spacers having pillar shapes which are formed using a deposited film having an insulating property joining the plate and which supports the plate relative to the diaphragm with a gap therebetween, wherein an electrostatic capacitance formed between the diaphragm and the plate is varied when the diaphragm vibrates relative to the plate.

In the fixed region of the diaphragm which does not vibrate relative to the plate, a parasitic capacitance is formed between the diaphragm and the plate, which are positioned opposite to each other; hence, it is preferable that the first spacers each having a high dielectric constant (higher than that of the air) be each reduced in area in plan view. That is, the plate is supported by the first spacers, which are not formed in ring shapes but are formed in a pillar shape, whereby it is possible to reduce the electrostatic capacitance between the diaphragm and the plate, thus improving the sensitivity. The geometric shapes of the first spacers are not necessarily limited to pillar shapes but can also be formed in flat shapes. The present invention does not need the support having a structurally closed shape but multiple supports which are formed in any shape for supporting the plate. It may be possible to reduce the parasitic capacitance by forming the plate or the diaphragm by use of an insulating substance in the region in which the diaphragm and the plate is positioned opposite to each other; however, this causes complexity in film structure with respect to at least one of the diaphragm and the plate

The aforementioned vibration transducer is manufactured in such a way that a plurality of holes are formed in the plate; isotropic etching is performed using the plate as a mask so as to remove a part of the deposited film, thus forming the gap between the plate and the diaphragm; and the first spacers are formed by use of the remaining deposited film. Since the plate is used as the etching mask so as to form the first spacers, it is possible to reduce the total number of masks, thus reducing the manufacturing cost.

That is, it is preferable that the plate has a plurality of holes which allow an etchant to transmit therethrough in isotropic etching, thus simultaneously forming the first spacers and the gap between the plate and the diaphragm.

The vibration transducer further includes a substrate and a plurality of second spacers having pillar shapes which are formed using a deposited film having an insulating property and which support the plate relative to the substrate with a gap therebetween, wherein an electrostatic capacitance formed between the diaphragm and the plate is varied when the diaphragm vibrates relative to the plate.

In consideration of a parasitic capacitance formed in the region in which the plate and the substrate are positioned opposite to each other via the second spacers having high dielectric constants (higher than the dielectric constant of the air) therebetween, it is preferable that the second spacers each be reduced in area in plan view. That is, the plate is supported by the second spacers which are formed not in ring shapes but in pillar shapes, whereby it is possible to reduce the electrostatic capacitance between the substrate and the plate, thus improving the sensitivity of the vibration transducer. The geometric shapes of the second spacers are not necessarily limited to pillar shapes but can also be formed in flat shapes. The present invention does not need the support having a structurally closed shape but multiple supports which are formed in any shapes for supporting the plate. It may be possible to reduce the parasitic capacitance in the region in which the plate and the substrate are positioned opposite to each other with the second spacers therebetween by forming the prescribed region of the plate joining the second spacers by use of an insulating substance; however, this causes complexity in the film structure of the plate.

The vibration transducer is manufactured in such a way that a plurality of holes is formed in the plate; isotropic etching is performed using the plate as a mask so as to remove a part of the deposited film, thus forming the gap between the plate and the substrate; and the second spacers are formed using the remaining of the deposited film. Since the plate is used as an etching mask for use in the formation of the second spacers, it is possible to reduce the number of masks, thus reducing the manufacturing cost.

That is, it is preferable that the plate has a plurality of holes allowing an etchant to transmit therethrough in isotropic etching, thus simultaneously forming the second spacers and the gap between the plate and the substrate.

In the vibration transducer, the distance between the center and the external end of the plate is smaller than the distance between the center and the external end of the diaphragm. In the region in which the diaphragm causes a relatively small amplitude of vibration or causes substantially no vibration, the electrostatic capacitance between the diaphragm and the plate varies very little or is not varied substantially. In the foregoing structure in which the external portion of the diaphragm is fixed to its upper or lower film, it causes a very small amplitude of vibration. The vibration transducer is designed such that the distance between the center and the external end of the plate becomes smaller than the distance between the center and the external end of the diaphragm, thus inhibiting the external portion of the diaphragm from being positioned opposite to the plate. When the plate and the diaphragm are both formed in a circular shape or when they have no recess in the outlines thereof, it is required that the external end of the plate is positioned inwardly of the external end of the diaphragm. When the plate and the diaphragm are both formed in a circular shape or when they have no recess in the outlines thereof, it is required that the shortest distance between the center and the external end of the plate be shorter than the shortest distance between the center and the external end of the diaphragm. Even when the plate is formed in a circular shape or does not have a recess in the outline thereof and even when the diaphragm has recesses in the outline thereof, it is required that the shortest distance between the center and the external end of the plate be shorter than the shortest distance between the center and the external end of the diaphragm. The aforementioned structure of the vibration transducer is capable of reducing the parasitic capacitance between the diaphragm and the plate, thus improving the sensitivity. In this connection, it may be possible to reduce the parasitic capacitance by forming the external portion of the diaphragm by use of an insulating substance or by forming the external region of the plate positioned opposite to the external portion of the diaphragm by use of an insulating substance, whereas this causes complexity in the film structure of at least one of the plate and the diaphragm.

Alternatively, the vibration transducer further includes a plurality of third spacers having pillar shapes which are formed using a deposited film having an insulating property which joins the substrate and the diaphragm and which supports the diaphragm relative to the substrate with a gap therebetween. When a parasitic capacitance is formed between the diaphragm and the substrate in the region in which they are positioned opposite to each other via the third spacers, it is preferable that the area of the third spacer (whose dielectric constant is higher than that of the air) be as small as possible. Each of the third spacers is not formed in a ring shape but in a pillar shape, whereby the diaphragm is supported by multiple third spacers; thus, it is possible to reduce the parasitic capacitance between the substrate and the diaphragm, thus improving the sensitivity. The geometric shapes of the third spacers are not necessarily limited to pillar shapes but can be formed in flat shapes. It is required that the third spacer not be formed in a closed wall structure, but a plurality of third spacers be formed in any shape for supporting the diaphragm. In this connection, it may be possible to reduce the parasitic capacitance between the diaphragm and the substrate in the region in which they are positioned opposite to each other via the third spacers by forming joint portions of the diaphragm joining the third spacers by use of insulating materials; however, this causes complexity in the film structure of the diaphragm.

Moreover, the plate is constituted of a center portion and a plurality of arms which are extended outwardly in a radial direction from the center portion, whereby the diaphragm is not positioned opposite to the plate at the arms and in the cutout regions between the arms. Due to the formation of the arms which are extended outwardly in a radial direction from the center portion of the plate, it is possible to reduce the parasitic capacitance formed between the diaphragm and the plate.

In a second aspect of the present invention, a vibration transducer includes a substrate, a diaphragm having a conductive property which is constituted of a center portion and a plurality of arms extended outwardly in a radial direction from the center portion, a plate having a conductive property which is constituted of a center portion, which is positioned opposite to the center portion of the diaphragm, and a plurality of arms extended outwardly in a radial direction from the center portion thereof, a plurality of plate supports for supporting the plate, and a plurality of diaphragm supports having pillar shapes which are positioned between the cutouts formed between the arms of the plate and which are positioned outwardly of the plate supports in the radial direction of the plate so as to support the diaphragm. The width of each arm of the diaphragm in the circumferential direction of the diaphragm becomes shortest in the intermediate region between the center portion and the joint portion at which each arm joins each diaphragm support but becomes longer in proximity to the joint portion. Herein, an electrostatic capacitance formed between the diaphragm and the plate is varied when the diaphragm vibrates relative to the plate.

In the above, the arms of the diaphragm are positioned alternately with the arms of the plate in plan view, wherein the distance between the plate supports which are positioned opposite to each other so as to support the plate is shorter than the distance between the diaphragm supports which are positioned opposite to each other so as to support the diaphragm. That is, the diaphragm supports which join the arms of the diaphragm and the substrate are positioned between the plate supports in the circumferential direction of the plate and are positioned externally of the plate supports in the radial direction of the plate. This increases the rigidity of the plate to be relatively higher than the rigidity of the diaphragm. The joint strength between the arms of the diaphragm and the diaphragm supports increase as the joint areas therebetween increase; thus, it is possible to increase the durability of the vibration transducer. When the joint areas are increased by increasing the lengths of the diaphragm supports in the radial direction of the diaphragm, the rigidity of the diaphragm is not changed (so that the sensitivity is not increased) irrespective of the substantial length of the diaphragm between the diaphragm supports, whereas the vibration transducer may be increased in size. To cope with such a possible drawback, the widths of the arms of the diaphragm in its circumferential direction are broadened at the joint areas so as to broaden the joint areas between the arms of the diaphragm and the diaphragm supports. This makes it possible to increase the sensitivity and durability of the vibration transducer without increasing its size. The geometric shapes of the diaphragm supports are not necessarily limited to pillar shapes but can be formed in flat shapes. That is, it is required for the diaphragm support to not have a structurally closed-wall structure but should be formed in any shape for supporting the diaphragm.

The rigidity of the diaphragm decreases as the widths of the arms of the diaphragm become short; hence, it is preferable that the widths of the arms of the diaphragm should be mostly broadened at the joint regions joining the diaphragm supports. That is, it is preferable that the widths of the arms of the diaphragm become longest at the joint regions joining the diaphragm supports.

It is preferable that the widths of the diaphragm supports be longer than the shortest width of the arm of the diaphragm at the intermediate position between the diaphragm support and the center portion of the diaphragm.

### BRIEF DESCRIPTION OF THE DRAWINGS

These and other objects, aspects, and embodiments of the present invention will be described in more detail with reference to the following drawings.

FIG. 1 is a plan view showing a sensor chip having an MEMS structure of a condenser microphone in accordance with a first embodiment of the present invention.

FIG. 2 is a longitudinal sectional view showing the structure of the condenser microphone.

FIG. 3 is an exploded view showing a lamination structure of films included in the condenser microphone.

FIG. 4A is a circuit diagram showing an equivalent circuit constituted of the sensor chip connected with a circuit chip.

FIG. 4B is a circuit diagram showing an equivalent circuit of the sensor chip having a guard electrode connected with the circuit chip.

FIG. 5 is a sectional view for use in the explanation of a first step of a manufacturing method of the condenser microphone.

FIG. 6 is a sectional view for use in the explanation of a second step of the manufacturing method of the condenser microphone.

FIG. 7 is a sectional view for use in the explanation of a third step of the manufacturing method of the condenser microphone.

FIG. 8 is a sectional view for use in the explanation of a fourth step of the manufacturing method of the condenser microphone.

FIG. 9 is a sectional view for use in the explanation of a fifth step of the manufacturing method of the condenser microphone.

FIG. 10 is a sectional view for use in the explanation of a sixth step of the manufacturing method of the condenser microphone.

FIG. 11 is a sectional view for use in the explanation of a seventh step of the manufacturing method of the condenser microphone.

FIG. 12 is a sectional view for use in the explanation of an eighth step of the manufacturing method of the condenser microphone.

FIG. 13 is a sectional view for use in the explanation of a ninth step of the manufacturing method of the condenser microphone.

FIG. 14 is a sectional view for use in the explanation of a tenth step of the manufacturing method of the condenser microphone.

FIG. 15 is a sectional view for use in the explanation of an eleventh step of the manufacturing method of the condenser microphone.

FIG. 16 is a sectional view for use in the explanation of a twelfth step of the manufacturing method of the condenser microphone.

FIG. 17 is a sectional view for use in the explanation of a thirteenth step of the manufacturing method of the condenser microphone.

FIG. 18 is a sectional view showing a part of the structure of the condenser microphone.

FIG. 19 is a sectional view showing another part of the structure of the condenser microphone.

FIG. 20 is a plan view showing a first variation of the diaphragm included in a condenser microphone in accordance with a second embodiment of the present invention.

FIG. 21 is a plan view showing a second variation of the diaphragm included in the condenser microphone of the second embodiment of the present invention.

### DESCRIPTION OF THE PREFERRED EMBODIMENTS

The present invention will be described in further detail by way of examples with reference to the accompanying drawings.

### 1. First Embodiment

(A) Constitution

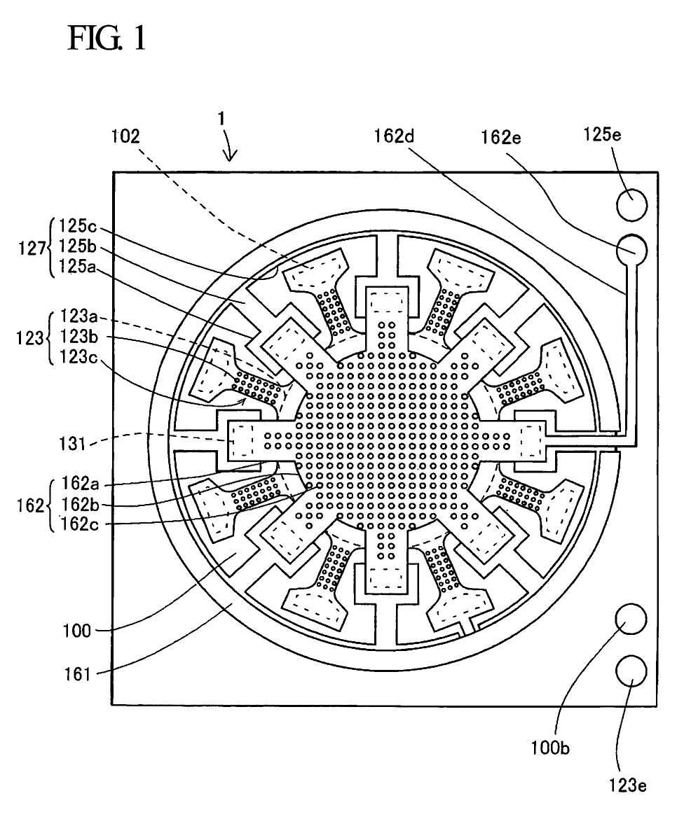

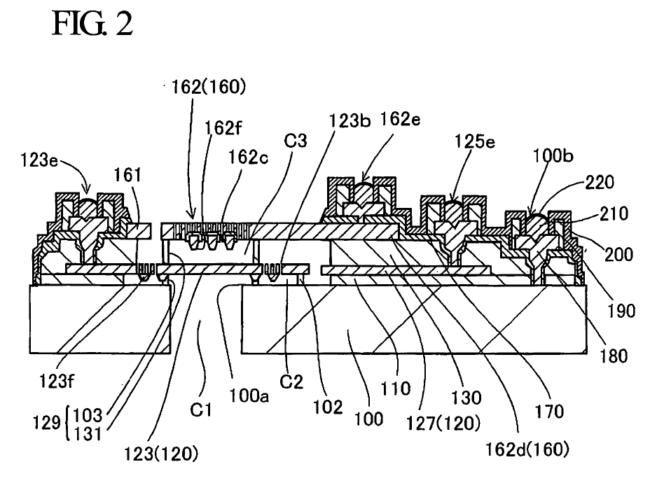

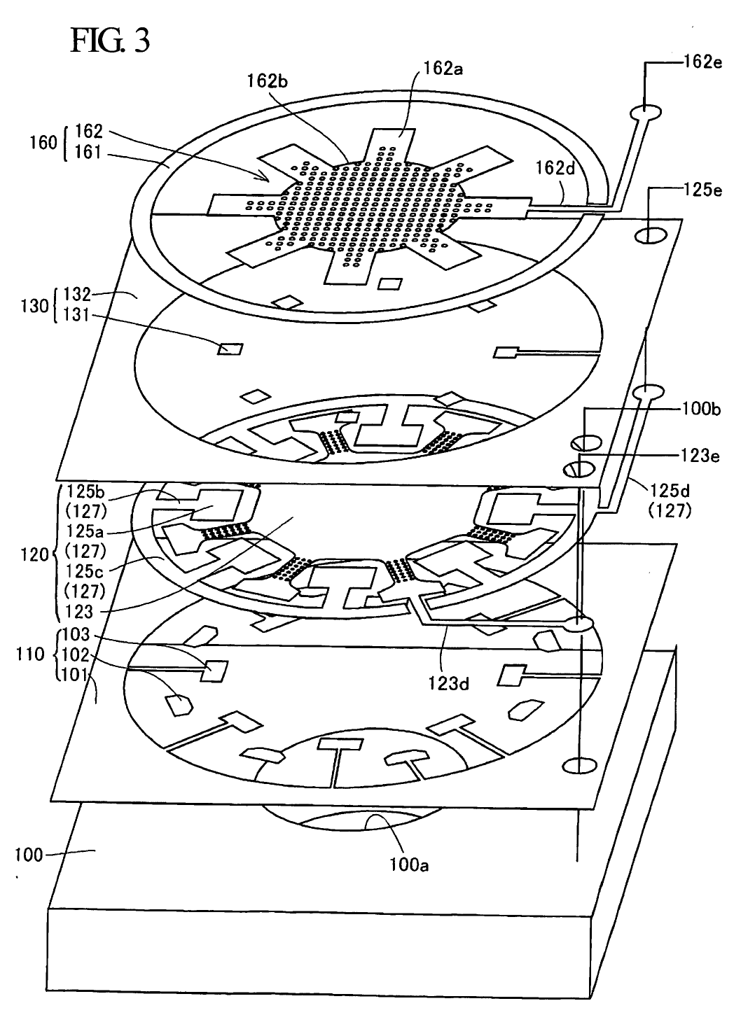

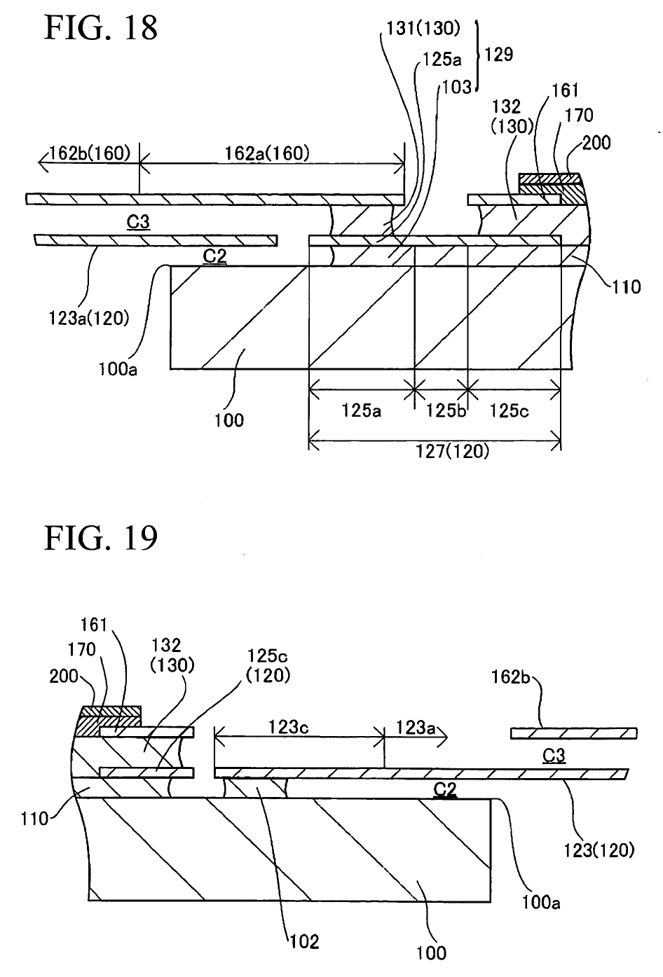

FIG. 1 shows a sensor chip having an MEMS structure of a condenser microphone in accordance with a first embodiment of the present invention. FIG. 2 diagrammatically shows the structure of the condenser microphone. FIG. 3 shows the lamination structure of films included in the condenser microphone 1. FIGS. 18 and 19 show prescribed parts of the structure of the condenser microphone 1 in detail. The condenser microphone 1 has a package (not shown) encapsulating the sensor chip and a circuit chip (including a power circuit and an amplification circuit, not shown).

The sensor chip of the condenser microphone 1 is composed of multiple films deposited on a substrate 100, i.e., a lower insulating film 110, a lower conductive film 120, an upper insulating film 130, an upper conductive film 160, and a surface insulating film 170. The lamination of films included in the MEMS structure of the condenser microphone 1 will be described below.

The substrate 100 is composed of a P-type monocrystal silicon; but this is not a restriction. The material of the substrate 100 should be determined to ensure the adequate rigidity, thickness, and strength in supporting multiple thin films deposited on a base substrate. A through-hole having an opening 100a is formed in the substrate 100, wherein the opening 100a corresponds to the opening of a back cavity C1.

The lower insulating film 110 joining the substrate 100, the lower conductive film 120, and the upper insulating film 130 is a deposited film composed of silicon oxide (SiOx). The lower insulating film 110 is used to form a plurality of third spacers 102 which are aligned in a circular manner with equal spacing therebetween, a plurality of guard spacers 103 which are aligned in a circular manner with equal spacing therebetween and are positioned internally of the third spacers 102, and a ring-shaped portion (actually, a rectangular-shaped portion having a circular opening) 101 which insulates a guard ring 125c and a guard lead 125d from the substrate 100.

The lower conductive film 120 joining the lower insulating film 110 and the upper insulating film 130 is a deposited film composed of polycrystal silicon entirely doped with impurities such as phosphorus (P). The lower conductive film 120 forms the diaphragm 123 and a guard portion 127 which is constituted of guard electrodes 125a and guard connectors 125b as well as the guard ring 125c and the guard lead 125d.

The upper insulating film 130 joining the lower conductive film 120, the upper conductive film 160, and the lower insulating film 110 is a deposited film composed of silicon oxide. The upper insulating film 130 forms a plurality of first spacers 131 which are aligned in a circular manner with prescribed distances therebetween, and a ring-shaped portion (actually a rectangular-shaped portion having a circular opening) 132 which is positioned outside of the first spacers 131, which supports an etching ring 161, and which insulates a plate lead 162d from the guard lead 125d.

The upper conductive film 160 joining the upper insulating film 130 is a deposited film composed of polycrystal silicon entirely doped with impurities such as phosphorus (P). The upper conductive film 160 forms the plate 162, the plate lead 162d, and the etching stopper 161.

The surface insulating film 170 joining the upper conductive film 160 and the upper insulating film 130 is a deposited film composed of silicon oxide having an insulating property.

The MEMS structure of the condenser microphone 1 has four terminals 125e, 162e, 123e, and 100b, which are formed using a pad conductive film 180 (which is a deposited film composed of AlSi having a conductive property), a bump film 210 (which is a deposited film composed of Ni having a conductive property), and a bump protection film 220 (which is a deposited film composed of Au having a superior anti-corrosion property and a conductive property). The side walls of the terminals 125e, 162e, 123e, and 100b are protected by means of a pad protection film 190 (which is a deposited film composed of SiN having an insulating property) and a surface protection film 200 (which is a deposited film composed of silicon oxide having an insulating property).

Next, the mechanical structure of the MEMS structure of the condenser microphone 1 will be described below.

The diaphragm 123 is formed using a thin single-layered deposited film having a conductive property and is constituted of a center portion 123a and a plurality of arms 123c which are extended outwardly in a radial direction from the center portion 123a. The diaphragm 123 is positioned in parallel with the substrate 100 and is supported by prescribed distances with the substrate 100 and the plate 162 while being insulated from the plate 162 by means of the third spacers 102 having pillar shapes which join the peripheral portion of the diaphragm 123 at multiple points. Specifically, the third spacers 102 join the arms 123c of the diaphragm 123 in proximity to their distal ends. Due to the cutouts formed between the arms 123c adjoining together in the diaphragm 123, the diaphragm 123 is reduced in rigidity compared with the foregoing diaphragm having no cutout. A plurality of diaphragm holes 123b is formed in each of the arms 123c, which is thus reduced in rigidity. Each arm 123c is elongated in length in the circumferential direction towards the center portion 123a of the diaphragm 123. This reduces concentration of stress at the boundary between the center portion 123a and each arm 123c. The diaphragm 123 is designed such that no bent portion is formed in the outline of each arm 123c in proximity to the boundary with the center portion 123a, thus preventing stress from being concentrated at the bent portion.

The third spacers 102 are aligned in the circumferential direction with equal spacing therebetween in the surrounding area of the opening 100a of the back cavity C1. Each of the third spacers 102 is formed using a deposited film having an insulating property in a pillar shape. The diaphragm 123 is supported above the substrate 100 by the third spacers 102 such that the center portion 123a thereof covers the opening 100a of the back cavity C1 in plan view. A gap C2 whose height substantially corresponds to the height or thickness of the third spacer 102 is formed between the substrate 100 and the diaphragm 123. The gap C2 is required to establish a balance between the internal pressure of the back cavity C1 and the atmospheric pressure. The gap C2 is reduced in height and is elongated in length in the radial direction of the diaphragm 123 so as to form a maximum acoustic resistance in a path which propagate sound waves (for vibrating the diaphragm 123) to reach the opening 100a of the back cavity C1.

A plurality of diaphragm bumps 123f is formed in the backside of the diaphragm 123 which is positioned opposite to the substrate 100. The diaphragm bumps 123f are projections for preventing the diaphragm 123 from being attached (or stuck) to the substrate 100. They are formed using the waviness of the lower conductive film 120 forming the diaphragm 123. Thus, dimples (or small recesses) are formed on the distal ends of the diaphragm bumps 123f.

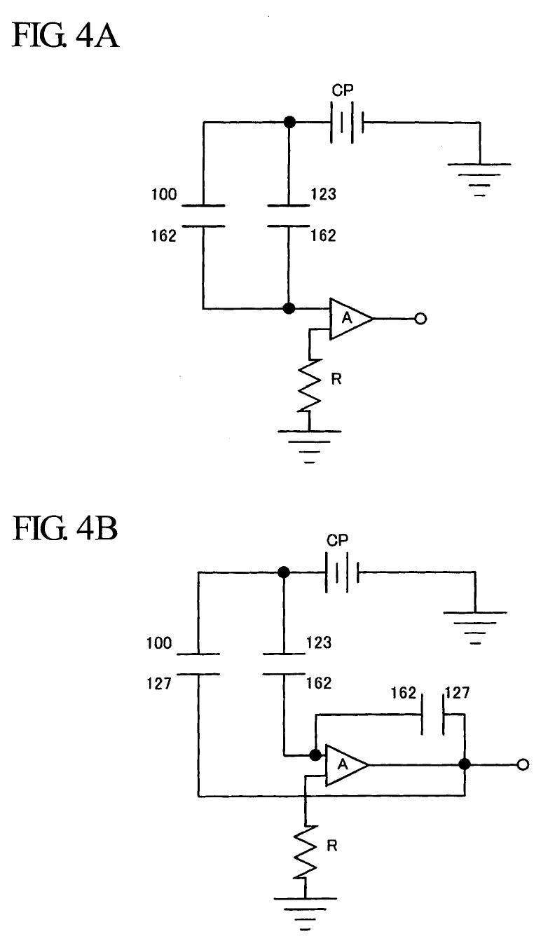

The diaphragm 123 is connected to the diaphragm terminal 123e via a diaphragm lead 123d which is extended from the distal end of one of the arms 123c. The diaphragm lead 123d is formed using the lower conductive film 120 as similarly to the diaphragm 123 in such a way that the width thereof becomes smaller than the width of the arm 123c. The diaphragm lead 123d is elongated to pass through the gap of the guard ring 125c toward the diaphragm terminal 123e. Since the diaphragm terminal 123e is short-circuited to the substrate terminal 100b via a circuit chip (not shown) as shown in FIGS. 4A and 4B, the same potential is applied to both of the substrate 100 and the diaphragm 123.

A parasitic capacitance occurs between the substrate and the diaphragm 123 when the potential of the substrate 100 differs from the potential of the diaphragm 123. Herein, the diaphragm 123 is supported by the third spacers 102 which adjoin each other with an air gap therebetween; hence, it is possible to reduce the parasitic capacitance in the condenser microphone 1 compared with the foregoing condenser microphone whose diaphragm is supported by a spacer having a ring-shaped wall structure.

The plate 162 is formed using a thin single-layer deposited film having a conductive property and is constituted of a center portion 162b and a plurality of arms 162a which are extended outwardly in a radial direction from the center portion 162b. The plate 162 is supported by the first spacers 131 having pillar shapes which join the peripheral portion of the plate 162 at multiple points. The plate 162 is positioned in parallel with the diaphragm 123 such that the center of the plate 162 substantially matches the center of the diaphragm 123 in plan view. Herein, the distance between the center of the plate 162 (i.e., the center of the center portion 162b) and the external end of the center portion 162b, i.e., the shortest distance between the center and the periphery of the plate 162, is shorter than the distance between the center of the diaphragm 123 (i.e., the center of the center portion 123a) and the external end of the center portion 123a, i.e, the shortest distance between the center and the periphery of the diaphragm 123. That is, the plate 162 is not positioned opposite to the peripheral portion of the diaphragm 123 causing a small amplitude of vibration. Cutouts are formed between the arms 162a of the plate 162 adjoining each other; hence, the plate 162 is not positioned opposite to the peripheral portion of the diaphragm 123 at the cutout regions thereof. The arms 123c of the diaphragm 123 are extended in the cutout regions of the plate 162. This increases the effective length of the diaphragm 123 causing vibration without increasing the parasitic capacitance.

A plurality of plate holes 162c is formed in the plate 162. The plate holes 162c serve as passages for propagating sound waves towards the diaphragm 123, and they also serve as through-holes for transmitting an etchant used for isotropic etching performed on the upper insulating film 130. The remaining parts of the upper insulating film 130 after etching are used to form the first spacers 131 and the ring-shaped portion 132, while the other parts removed by etching are used to form a gap C3 between the diaphragm 123 and the plate 162. That is, the plate holes 162c serve as through-holes allowing the etchant to reach the upper insulating film 130 so as to simultaneously form the first spacers 131 and the gap C3. For this reason, the plate holes 162c are appropriately aligned in consideration of the height of the gap C3, the shapes of the first spacers 130, and the etching speed. Specifically, the plate holes 162c are collectively formed with equal spacing therebetween in the center portion 162b and the arms 162a except for the joint portions of the plate 162 joining with the first spacers 131. As the distances between the adjacent plate holes 162c get smaller, it is possible to reduce the width of the ring-shaped portion 132 (formed using the upper insulating film 130), thus reducing the overall size of a chip. On the other hand, the rigidity of the plate 162 gets smaller as the distances between the adjacent plate holes 162c get smaller.

The first spacers 131 join the guard electrodes 125a, which are positioned at the same position as the diaphragm 123 and which are formed using the lower conductive film 120 forming the diaphragm 123. The first spacers 131 are formed using the upper insulating film 130, i.e., a deposited film having an insulating property joined to the plate 162. The first spacers 131 are aligned with equal spacing therebetween in the surrounding area of the opening 100a of the back cavity C1. Since the first spacers 131 are positioned in the cutout regions between the arms 123c adjoining each other in the diaphragm 123, it is possible to reduce the maximum diameter of the diaphragm 123 to be smaller than the maximum diameter of the plate 162. This relatively increases the rigidity of the plate 162 while reducing the parasitic capacitance between the plate 162 and the substrate 100.

The plate 162 is supported above the substrate 100 by means of a plurality of second spacers 129 having pillar shapes which are constituted of the guard spacers 103, the guard electrodes 125a, and the first spacers 131. The second spacers 129 are each formed in a multilayered structure including deposited films. The gap C3 is formed between the plate 162 and the diaphragm 123 by the second spacers 129, so that the gaps C2 and C3 are formed between the plate 162 and the substrate 100. Due to insulating properties of the guard spacers 103 and the first spacers 131, the plate 162 is insulated from the substrate 100.

When the potential of the plate 162 differs from the potential of the substrate 100 due to absence of the guard electrodes 125a, a parasitic capacitance occurs in the prescribed region in which the plate 162 and the substrate 100 are positioned opposite to each other in plan view, wherein the parasitic capacitance may increase by way of the intervention of insulating substances arranged therebetween (see FIG. 4A). In the present embodiment, the second spacers 129 having pillar shapes are formed using the guard spacers 103, the guard electrodes 125a, and the first spacers 131, wherein they are physically isolated from each other so as to support the plate 162 above the substrate 100. Even in the absence of the guard electrodes 125a, it is possible to reduce the parasitic capacitance in the condenser microphone 1 of the present invention compared with the foregoing structure in which the plate is supported above the substrate via the insulating member having a ring-shaped wall structure.

A plurality of plate bumps 162f is formed on the backside of the plate 162 positioned opposite to the diaphragm 123. The plate bumps 162f are formed using a silicon nitride film (SiN) joining the upper conductive film 160, and a polycrystal silicon film joining the silicon nitride film. The plate bumps 162f prevent the diaphragm 123 from being attached (or stuck) to the plate 162.

A plate lead 162d whose width is smaller than the width of the arm 162a is extended from the distal end of the arm 162a of the plate 162 toward the plate terminal 162e. The plate lead 162d is formed using the upper conductive film 160 forming the plate 162. The wiring path of the plate lead 162d substantially overlap the wiring path of the guard lead 125d in plan view; hence, it is possible to reduce the parasitic capacitance formed between the plate lead 162d and the substrate 100.

(B) Operation

Next, the overall operation of the condenser microphone 1 will be described with reference to FIGS. 4A and 4B, each of which shows an equivalent circuit including the sensor chip and the circuit chip which are connected together. A charge pump P included in the circuit chip applies a stable bias voltage to the diaphragm 123. The sensitivity of the condenser microphone 1 increases as the bias voltage increases, wherein adherence (or stiction) may easily occur between the diaphragm 123 and the plate 162. For this reason, the rigidity of the plate is an important factor in designing the MEMS structure of the condenser microphone 1.

Sound waves (entered from a through-hole of a package, not shown) are transmitted through the plate holes 162c and the cutout regions between the arms 162a of the plate 162 so as to reach the diaphragm 123. Since sound waves of the same phase are propagated along both of the surface and backside of the plate 162, the plate 162 would not vibrate substantially. Sound waves reaching the diaphragm 123 make the diaphragm 123 vibrate relative to the plate 162. When the diaphragm 123 vibrates due to sound waves, the electrostatic capacitance of a parallel-plate condenser constituted of opposite electrodes (corresponding to the diaphragm 123 and the plate 162) is varied. Variations of electrostatic capacitance are converted into electric signals, which are then amplified by an amplifier A included in the circuit chip. The amplifier A should be necessarily installed in the package because of the high-impedance output of the sensor chip.

Since the diaphragm 123 is short-circuited with the substrate 100, a parasitic capacitance is formed between the substrate 100 and the plate 162 (which does not vibrate relatively) in the circuitry of FIG. 4A which does not include the guard electrode 125a in the guard portion 127. In the circuitry of FIG. 4B, the output terminal of the amplifier A is connected to the guard portion 127 so as to form a voltage-follower circuit using the amplifier A, whereby it is possible to avoid the occurrence of the parasitic capacitance between the plate 162 and the substrate 100. Since the guard electrodes 125a are arranged between the substrate 100 and the arms 162a of the plate 162 in the prescribed regions in which the arms 162a are positioned opposite to the substrate 100 in plan view, it is possible to reduce the parasitic capacitance between the substrate 100 and the arms 162a of the plate 162. Due to the wiring of the guard lead 125d (which is extended from the guard ring 125c connecting the guard electrodes 125a together toward the guard terminal 125e) in the region in which the plate lead 162d (which is extended from the arm 162a of the plate 162) is positioned opposite to the substrate 100 in plan view, no parasitic capacitance is formed between the plate lead 162d and the substrate 100. The guard ring 125c connects the guard electrodes 125a together substantially with the minimum distances therebetween in the surrounding area of the diaphragm 123. By increasing the lengths of the guard electrodes 125a to be longer than the lengths of the arms 162a of the plate 162, it is possible to further reduce the parasitic capacitance.

It is possible to incorporate the constituent elements of the circuit chip such as the charge pump P and the amplifier A into the sensor chip, thus forming the condenser microphone 1 having a single-chip structure.

(C) Manufacturing Method

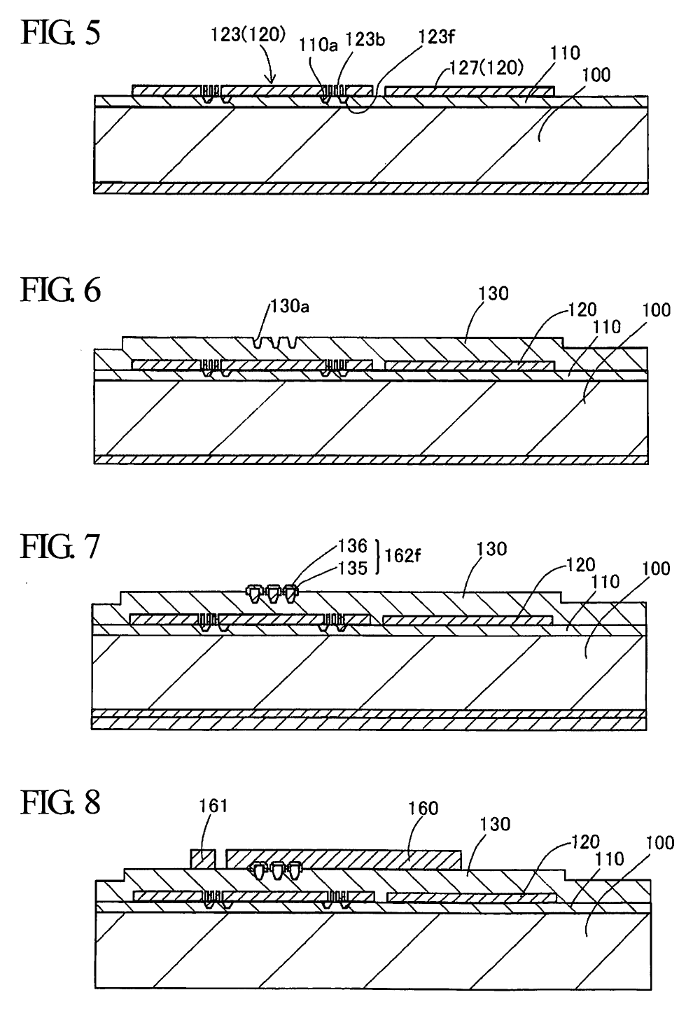

Next, the manufacturing method of the condenser microphone 1 will be described with reference to FIGS. 5 to 17.

In a first step of the manufacturing method shown in FIG. 5, the lower insulating film 110 composed of silicon oxide is entirely formed on the surface of the substrate 100. Next, a lower insulating film 110 is etched using a photoresist mask so as to form dimples 110a used for the formation of the diaphragm bumps 123f. Then, the lower conductive film 120 composed of polycrystal silicon is formed on the surface of the lower insulating film 110 by way of CVD (i.e. Chemical Vapor Deposition). Thus, the diaphragm bumps 123f are formed on the dimples 110a. Lastly, the lower conductive film 120 is etched using a photoresist mask so as to form the diaphragm 123 and the guard portion 127, both of which are formed using the lower conductive film 120.

In a second step of the manufacturing method shown in FIG. 6, the upper insulating film 130 composed of silicon oxide is entirely formed on the surfaces of the lower insulating film 110 and the lower conductive film 120. Next, etching is performed using a photoresist mask so as to form dimples 130a (used for the formation of the plate bumps 162f) in the upper insulating film 130.

In a third step of the manufacturing method shown in FIG. 7, the plate bumps 162f are formed using a polysilicon film 135 and a silicon nitride film 136 on the surface of the upper insulating film 130. Since the silicon nitride film 136 is formed after the patterning of the polycrystal silicon film 135 by way of the known method, all the exposed portions of the polysilicon film 135 which project from the dimples 130a are covered with the silicon nitride film 136. The silicon nitride film 136 is an insulating film that prevents the diaphragm 123 from being short-circuited with the plate 162 in adherence (or stiction).

In a fourth step of the manufacturing method shown in FIG. 8, the upper conductive film 160 composed of polycrystal silicon is formed on the exposed surface of the upper insulating film 130 and the surface of the silicon nitride film 136 by way of CVD. Next, the upper conductive film 160 is etched using a photoresist mask so as to form the plate 162, the plate lead 162d, and the etching stopper 161. In this step, the plate holes 162c are not formed in the plate 162.

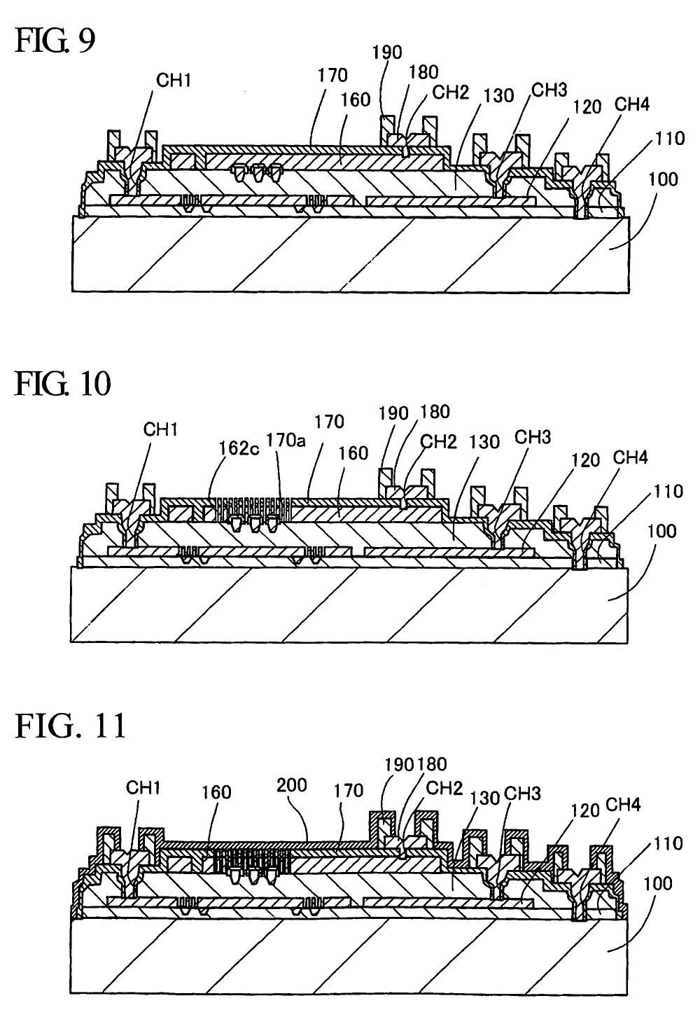

In a fifth step of the manufacturing method shown in FIG. 9, contact holes CH1, CH3, and CH4 are formed in the upper insulating film 130; subsequently, the surface insulating film 170 composed of silicon oxide is formed on the entire surface. In addition, the surface insulating film 170 is etched using a photoresist mask so as to form a contact hole CH2 and to simultaneously remove the prescribed portions of the surface insulating film 170 remaining in the bottoms of the contact holes CH1, CH3, and CH4. Next, a pad conductive film 180 composed of AlSi is formed and embedded in the contact holes CH1, CH2, CH3, and CH4. Then, the pad conductive film 180 is subjected to patterning so as to leave the prescribed portions covering the contact holes CH1, CH2, CH3, and CH4 in accordance with the known method. Furthermore, a pad protection film 190 composed of silicon nitride is formed on the surface insulating film 170 and the pad conductive film 180 by way of CVD. Then, the pad conductive film 190 is subjected to patterning by way of the known method, thus leaving prescribed portions thereof in the surrounding area of the pad conductive film 180.

In a sixth step of the manufacturing method shown in FIG. 10, anisotropic etching is performed using a photoresist mask so as to form holes 170a in correspondence with the plate holes 162c, whereby the plate holes 162c are formed in the upper conductive film 160. This step is performed continuously so that the surface insulating film 170 having the holes 170a serves as a resist mask for the upper conductive film 160.

In a seventh step of the manufacturing method shown in FIG. 11, a surface protection film 200 composed of silicon oxide is formed on the surfaces of the surface insulating film 170 and the pad protection film 190. In this step, the surface protection film 200 is partially embedded in the holes 170a of the surface insulating film 170 and the plate holes 162c.

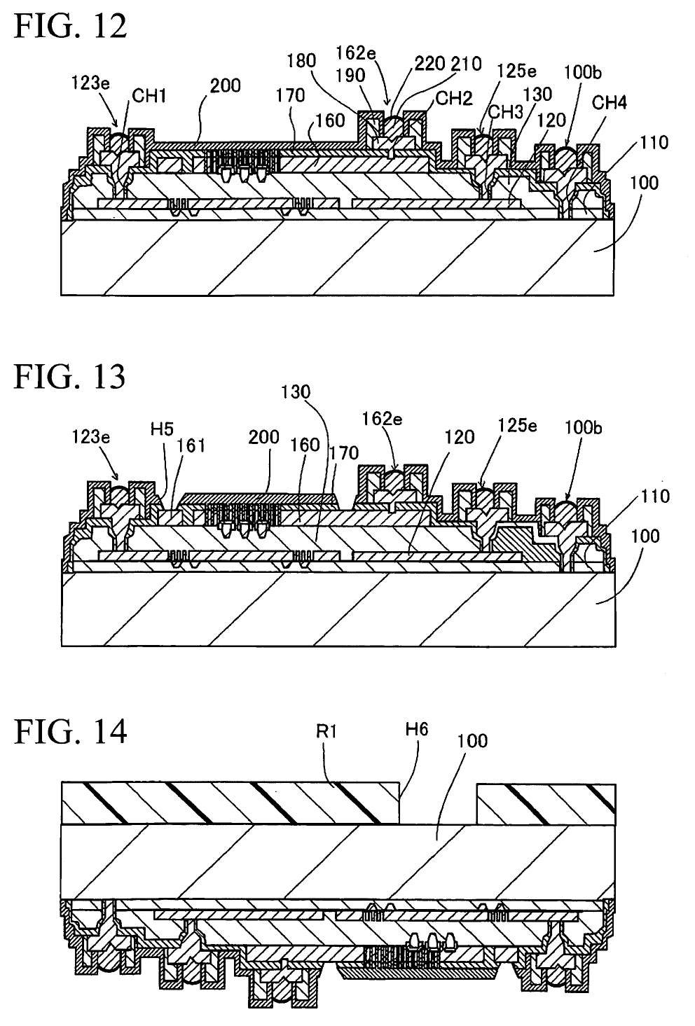

In an eighth step of the manufacturing method shown in FIG. 12, a bump film 210 composed of Ni is formed on the prescribed portions of the pad conductive film 180 embedded in the contact holes CH1, CH2, CH3, and CH4. Then, a bump protection film 220 composed of Au is formed on the surface of the bump film 210. In this step, the backside of the substrate 100 is polished so as to define the desired thickness for the substrate 100.

In a ninth step of the manufacturing method shown in FIG. 13, etching is performed using a photoresist mask on the surface protection film 200 and the surface insulating film 170 so as to form a through-hole H5 for exposing the etching stopper 161.

The film formation process is completed with respect to the surface side of the substrate 100 by way of the aforementioned steps. After completion of the film formation process in the surface side of the substrate 100, a photoresist mask R1 having a through-hole H6 (used for the formation of the back cavity C1) is formed on the backside of the substrate 100 in a tenth step of the manufacturing method shown in FIG. 14.

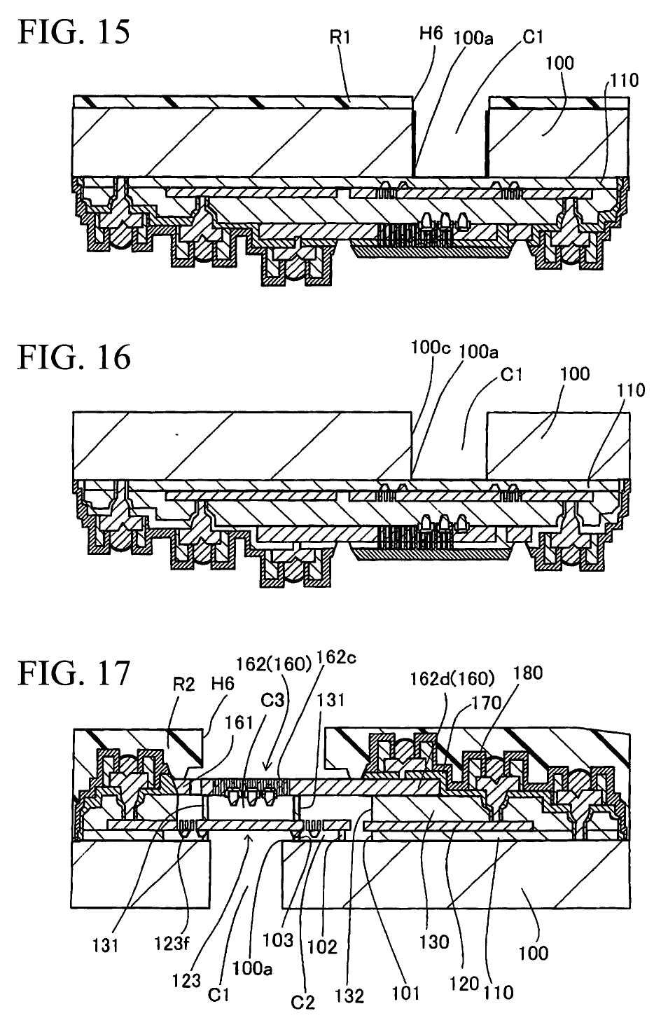

Subsequently, in an eleventh step of the manufacturing method shown in FIG. 15, Deep-RIE (where RIE stands for Reactive Ion Etching) is performed so as to form a through-hole in the substrate 100, wherein the lower insulating film 110 serves as an etching stopper.

In a twelfth step of the manufacturing method shown in FIG. 16, the photoresist mask R1 is removed, then a wall surface 100c of the through-hole (which is roughly formed in the substrate 100 by way of Deep-RIE) is smoothed.

In a thirteenth step of the manufacturing method shown in FIG. 17, isotropic etching is performed using a photoresist mask R2 and a buffered hydrofluoric acid (BHF) the surface protection film 200 and the surface insulating film 170 are removed from the plate 162 and the plate lead 162d. In addition, the ring-shaped portion 132, the first spacers 131, and the gap C3 are formed by partially removing the upper insulating film 130. Furthermore, the guard spacer 103, the third spacers 102, the ring-shaped portion 101, and the gap C2 are formed by partially removing the lower insulating film 110. At this time, the BHF serving as an etchant enters into a through-hole H6 of the photoresist mask R2 and the opening 100a of the substrate 100. The outline of the upper insulating film 130 is defined by the plate 162 and the plate lead 162d. That is, the ring-shaped portion 132 and the first spacers 131 are formed by way of self-alignment of the plate 162 and the plate lead 162d. As shown in FIG. 18, undercuts are formed on the edges of the ring-shaped portion 132 and the first spacers 131 by way of isotropic etching. The outline of the lower insulating film 110 is defined by the opening 100a of the substrate 100, the diaphragm 123, the diaphragm lead 123d, the guard electrodes 125a, the guard connectors 125b, and the guard ring 125c. That is, the guard spacer 103 and the third spacers 102 are formed by way of self-alignment of the diaphragm 123. In addition, undercuts are formed on the edges of the guard spacers 103 and the first spacers 131 by way of isotropic etching (see FIGS. 18 and 19). Since the guard spacers 103 and the first spacers 131 are formed in this step, the second spacers 129 for supporting the plate 162 above the substrate 100 are formed except for the guard electrodes 125a.

Lastly, the photoresist mask R2 is removed, then the substrate 100 is subjected to dicing, thus completing the production of the sensor chip of the condenser microphone 1. Thereafter, the sensor chip and the circuit chip are bonded onto the substrate of the package; the aforementioned terminals are connected together by way of wire bonding; then, a package cover (not shown) is mounted on the substrate of the package; thus, it is possible to close the back cavity C1 in an airtight manner in the backside of the substrate 100.

### 2. Second Embodiment

The second embodiment of the present invention is directed to the condenser microphone 1, which is described with reference to FIGS. 1 to 19, wherein the third spacers 102 are referred to as diaphragm supports 102, the second spacers 129 are referred to as plate supports 129, and the first spacers 131 are referred to as plate spacers.

As described in the first embodiment in which the sensitivity can be increased by increasing the rigidity of the plate 162, while it is possible to reduce the rigidity of the diaphragm 123, to reduce the stress occurring during the film formation process, and to reduce the parasitic capacitance by supporting the diaphragm 123 by use of pillar structures. However, the “miniature” condenser microphone 1 whose diaphragm 123 is supported using pillar structures may have a difficulty in achieving an adequate durability. In this sense, the second embodiment is designed to increase the sensitivity and durability of the condenser microphone 1 in which the diaphragm 123 is supported using pillar structures without substantially increasing the size of the condenser microphone 1.

Since the condenser microphone 1 according to the second embodiment has a constitution substantially identical to that of the first embodiment, the detailed description thereof will not be repeated, whereas the second embodiment can be explained in more detail by way of the following descriptions.

Each of the arms 123c of the diaphragm 123 is increased in width in each of the joint regions at which the arms 123c join the diaphragm supports 102 and is elongated in length in the circumferential direction of the diaphragm 123. Specifically, each of the arms 123c of the diaphragm 123 becomes narrow in width in proximity to the center portion 123a in the direction departing from the center portion 123a, while it becomes wider in width in proximity to and toward each of the diaphragm supports 102. That is, the width of the arm 123c in the circumferential direction of the diaphragm 123 becomes shortest in the intermediate region between the center portion 123a and the diaphragm support 102 but becomes longer in the region at which the arm 123c joins the diaphragm support 102. For this reason, it is possible to increase the durability while increasing the overall joint area between the diaphragm 123 and the diaphragm supports 102 without substantially increasing the overall radius of the diaphragm 123. Since the width of the arm 123c (lying in the circumferential direction of the diaphragm 123) becomes longest in the region in which the arm 123c joins the diaphragm support 102, it is possible to secure high joint strength of the diaphragm 123 while reducing the rigidity of the diaphragm 123.

In addition, the diaphragm supports 102 are positioned between the arms (or joint portions) 162a of the plate 162 and externally of the plate supports 129 in the radial direction of the plate 162. This reduces the rigidity of the diaphragm 123 compared with the rigidity of the plate 162. The widths of the diaphragm supports 102 (in the circumferential direction of the diaphragm 123) are longer than the widths of the arms 123c in their regions positioned between the center portion 123a of the diaphragm 123 and the diaphragm supports 102. Thus, it is possible to secure an adequate joint strength between the arms 123c of the diaphragm 123 and the diaphragm supports 102. The gap C2 whose height substantially matches the thickness of the diaphragm supports 102 is formed between the substrate 100 and the diaphragm 123. As described above, the gap is required to establish a balance between the internal pressure of the back cavity C1 and the atmospheric pressure.

The overall operation of the condenser microphone 1 of the second embodiment is identical to that of the first embodiment which is described with reference to FIGS. 4A and 4B; hence, the description thereof will not be repeated.

The manufacturing method of the condenser microphone 1 of the second embodiment is identical to that of the first embodiment which is described with reference to FIGS. 5 to 17; hence, the description thereof will not be repeated.

The diaphragm 123 adapted to the second embodiment is identical to that of the first embodiment shown in FIGS. 1 and 3; but the second embodiment provides variations of the diaphragm 123, which will be described below.

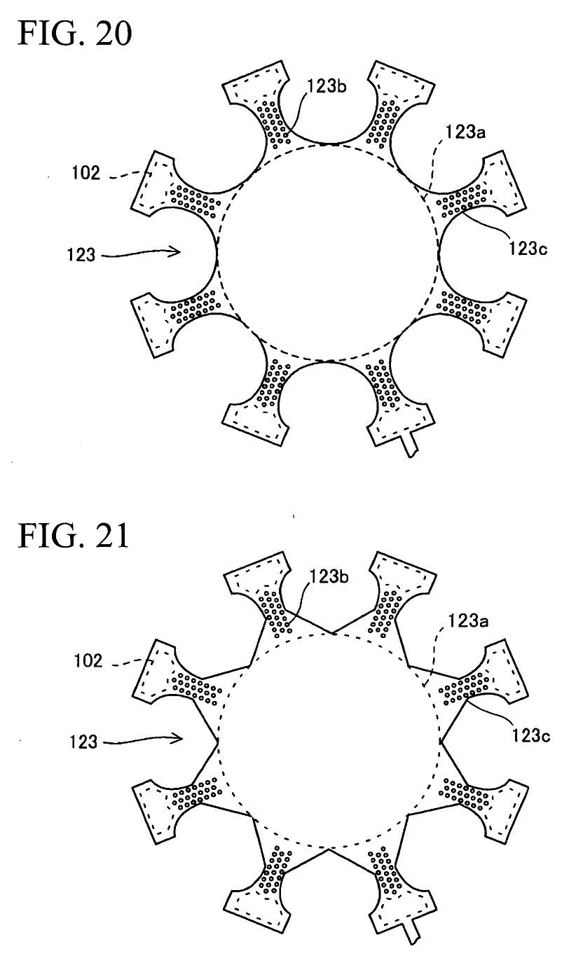

FIGS. 20 and 21 shows variations of the diaphragm 123, in which the outlines of the arms 123c adjoining together in the diaphragm 123 smoothly join the outline of the center portion 123a and are each curved inwardly in the circumferential direction of the diaphragm 123. Specifically, FIG. 20 shows a first variation of the diaphragm 123 in which the outline thereof is seamlessly curved between the center portion 123a and the joint regions of the arms 123c joining the diaphragm supports 102 without bent portions, wherein it is possible to reduce concentration of stress at the arms 123c of the diaphragm 123, which are thus not bent easily. FIG. 21 shows a second variation of the diaphragm 123 in which the outline thereof smoothly continues between the arms 123c and the center portion 123a. In FIGS. 20 and 21, the diaphragm holes 123b are not aligned in the circumferential direction of the diaphragm 123, whereby it is possible to reduce concentration of stress at the arms 123c, which are thus hardly bent.

In the first and second embodiments, the aforementioned materials and dimensions are merely illustrative and not restrictive, wherein the descriptions regarding the addition, deletion, and change of order of steps in manufacturing, which may be obvious to those skilled in the art are omitted for the sake of simplicity of the explanation. For example, the film composition, film formation method, outline formation methods of films, and order of steps in manufacturing are not necessarily limited those described above but can be appropriately selected in consideration of the combination of materials of films having desired properties, thicknesses of films, required precisions for defining outlines of films, and the like.

Lastly, the present invention is not necessarily limited to the first and second embodiments and variations, which can be further modified within the scope of the invention as defined by the appended claims.

1. A vibration transducer comprising:
a diaphragm composed of a deposited film having a conductive property;
a plate composed of a deposited film having a conductive property, which is positioned opposite to the diaphragm; and
a plurality of first spacers having pillar shapes which are formed using a deposited film having an insulating property joining the plate and which supports the plate relative to the diaphragm with a gap therebetween,
wherein an electrostatic capacitance formed between the diaphragm and the plate is varied when the diaphragm vibrates relative to the plate.

2. A manufacturing method for manufacturing a vibration transducer including a diaphragm having a conductive property, a plate having a conductive property, and a plurality of first spacers having pillar shapes which are formed using a deposited film having an insulating property so as to support the plate relative to the diaphragm with a gap therebetween, said manufacturing method comprising the steps of:
forming the plate having a plurality of holes;
performing isotropic etching using the plate as a mask so as to remove a part of the deposited film, thus forming the gap between the plate and the diaphragm; and
forming the first spacers by use of remaining of the deposited film.

3. A vibration transducer according to claim 1, wherein a plurality of holes is formed in the plate so as to allow an etchant to transmit therethrough in isotropic etching, thus simultaneously forming the first spacers and the gap between the plate and the diaphragm.

4. A vibration transducer comprising:
a substrate;
a diaphragm composed of a deposited film having a conductive property;
a plate composed of a deposited film having a conductive property, which is positioned opposite to the diaphragm; and
a plurality of second spacers having pillar shapes which are formed using a deposited film having an insulating property joining with the substrate and the plate and which support the plate relative to the substrate with a gap there between,
wherein an electrostatic capacitance formed between the diaphragm and the plate is varied when the diaphragm vibrates relative to the plate.

5. A manufacturing method for manufacturing a vibration transducer including a substrate, a diaphragm having a conductive property, a plate having a conductive property, and a plurality of second spacers having pillar shapes which are formed using a deposited film having an insulating property and which supports the plate relative to the substrate with a gap therebetween, said manufacturing method comprising the steps of:
forming a plurality of holes in the plate;
performing isotropic etching using the plate as a mask so as to remove a part of the deposited film, thus forming the gap between the plate and the substrate; and
forming the second spacers by use of remaining of the deposited film.

6. A vibration transducer according to claim 4, wherein a plurality of holes is formed in the plate so as to allow an etchant to transmit therethrough in isotropic etching, thus simultaneously forming the second spacers and the gap between the plate and the substrate.

7. A vibration transducer comprising:
a diaphragm composed of a deposited film having a conductive property; and
a plate composed of a deposited film having a conductive property, which is positioned opposite to the diaphragm,
wherein a distance between a center and an external end of the plate is smaller than a distance between a center and an external end of the diaphragm, and
wherein an electrostatic capacitance formed between the diaphragm and the plate is varied when the diaphragm vibrates relative to the plate.

8. A vibration transducer comprising:
a substrate;
a diaphragm composed of a deposited film having a conductive property;
a plate composed of a deposited film having a conductive property, which is positioned opposite to the diaphragm; and
a plurality of third spacers having pillar shapes which are formed using a deposited film having an insulating property joining with the substrate and the diaphragm and which supports the diaphragm relative to the substrate with a gap therebetween,
wherein an electrostatic capacitance formed between the diaphragm and the plate is varied when the diaphragm vibrates relative to the plate.

9. A vibration transducer according to claim 1, wherein the plate is constituted of a center portion and a plurality of arms which are extended outwardly in a radial direction from the center portion.

10. A vibration transducer according to claim 3, wherein the plate is constituted of a center portion and a plurality of arms which are extended outwardly in a radial direction from the center portion.

11. A vibration transducer according to claim 4, wherein the plate is constituted of a center portion and a plurality of arms which are extended outwardly in a radial direction from the center portion.

12. A vibration transducer according to claim 6, wherein the plate is constituted of a center portion and a plurality of arms which are extended outwardly in a radial direction from the center portion.

13. A vibration transducer according to claim 7, wherein the plate is constituted of a center portion and a plurality of arms which are extended outwardly in a radial direction from the center portion.

14. A vibration transducer according to claim 8, wherein the plate is constituted of a center portion and a plurality of arms which are extended outwardly in a radial direction from the center portion.

15. A vibration transducer comprising:
a substrate;
a diaphragm composed of a deposited film having a conductive property, which is constituted of a center portion and a plurality of arms extended outwardly in a radial direction from the center portion;
a plate composed of a deposited film having a conductive property, which is constituted of a center portion, which is positioned opposite to the center portion of the diaphragm, and a plurality of arms extended outwardly in a radial direction from the center portion thereof;
a plurality of plate supports for supporting the plate; and
a plurality of diaphragm supports having pillar shapes which are positioned between cutouts formed between the arms of the plate and which are positioned outwardly of the plate supports in the radial direction of the plate, thus supporting the diaphragm,
wherein a width of each arm of the diaphragm in a circumferential direction of the diaphragm becomes shortest in an intermediate region between the center portion and a joint portion at which each arm joins each diaphragm support but becomes longer in proximity to the joint portion, and
wherein an electrostatic capacitance formed between diaphragm and the plate is varied when the diaphragm vibrates relative to the plate.

16. A vibration transducer according to claim 15, wherein the width of each arm of the diaphragm becomes longest in the joint portion at which each arm joins each diaphragm support.

17. A vibration transducer according to claim 15, wherein a width of each diaphragm support in the circumferential direction of the diaphragm is longer than the shortest width of each arm at the intermediate portion between the joint portion and the center portion of the diaphragm.

18. A vibration transducer according to claim 16, wherein a width of each diaphragm support in the circumferential direction of the diaphragm is longer than the shortest width of each arm at the intermediate portion between the joint portion and the center portion of the diaphragm.

19. A vibration transducer according to claim 4, further comprising a plurality of first spacers having pillar shapes which are formed using a deposited film having an insulating property joining the plate and which supports the plate relative to the diaphragm with a gap therebetween.

20. A vibration transducer according to claim 4, wherein the diaphragm is constituted of a center portion and a plurality of arms extended outwardly in a radial direction from the center portion and the plate is constituted of a center portion and a plurality of arms extended outwardly in a radial direction from the center portion,
said vibration transducer further comprising;
a plurality of plate supports for supporting the plate, and
a plurality of diaphragm supports having pillar shapes which are positioned between cutouts formed between the arms of the plate and which are positioned outwardly of the plate supports in the radial direction of the plate, thus supporting the diaphragm,
wherein a width of each arm of the diaphragm in a circumferential direction of the diaphragm becomes shortest in an intermediate region between the center portion and a joint portion at which each arm joins each diaphragm support but becomes longer in proximity to the joint portion.
